(19) United States
(12) Patent Application Publication
(10) Pub. No.: US 2002/0147693 A1
(43) Pub. Date: Oct. 10, 2002

(54) Method and system for dynamic accounting of service and equipment usage

(75) Inventors: Dwip N. Banerjee, Austin, TX (US); Rabindranath Dutta, Austin, TX (US)

Correspondence Address: Jeffrey L. Streets, P.O. Box 1612, Cypress, TX, 77410, US

(73) Assignee: INTERNATIONAL BUSINESS MACHINES CORPORATION, ARMONK, NY (US)

(21) Appl. No.: 09/826,751

(22) Filed: Apr. 5, 2001

(51) Int. Cl. G06F 17/00

(52) U.S. Cl. 705/400

(57) ABSTRACT

A computer system, computer program product and method for calculating user fees associated with an amount of equipment usage. A server monitors usage a plurality of devices over a communications network, such as the Internet. Usage of the devices is charged to one or more users identified as using the devices. The user fees are preferably accumulated over a billing period before submitting an invoice of total user fees to each user. The amount of usage may be measured as a quantity selected from the group consisting of time, repetitions, workload and combinations thereof. The invention allows the possibility of having rate schedules that vary according to a factor selected from time of day, day of the week, device type, device features, device location, current demand conditions and combinations thereof. The system may further include an exercise profiler and a dietary profiler that provide fitness settings, programs and advice.

### BACKGROUND OF THE INVENTION

1. Field of the Invention

The present invention relates to a method and system for determining a user fee to be charged by monitoring the service and equipment usage.

2. Description of the Related Art

The cost of equipment rentals, or other equipment sharing arrangements, are generally charged to the user on the basis of a cost per amount of time used. The practice of time-based user fees has a number of advantages. First, time is something that is easily tracked and monitored by both the user and the equipment provider so that disputes are less likely to arise. Second, people are accustomed to estimating the amount of time that the equipment may be needed. In fact, even the operators of the equipment are typically paid by the hour.

However, there are certain inequities that arise as a result of time-based user fees. For example, a rental car may be quoted as costing a fixed amount per day of rental, regardless of whether the car is driven constantly during the rental period or whether the car is driven only a few miles before being sitting idle for the majority of the rental period. Accordingly, some rental agreements now provide a mileage cap at the fixed rental fee, but charge an additional amount for each mile driven beyond the mileage cap. This additional charge is an acknowledgement that the value of the rental car is not just a function of time, but is also a function of the extent of use.

Quantifying or measuring an amount of car usage is relatively easy given the presence of an odometer and the fact that the number of cars, usually just one, is known at the outset of the rental period. However, there is a need to provide other services and equipment to users in an environment where the user can select the service or equipment as needed and use as much or as little of that service or equipment as determined necessary. For example, an executive suite arrangement can be configured where tenants have a number of business-related services, such as answering service, typing service and the like, and a number of equipment types, such as photocopiers, desks, and the like, made available to them. Charging for executive suite usage is much more complex than for a rental car, since the quantity of service and equipment used is more a function of the usage and less a function of time.

However, some service and equipment usage is even more difficult and time-consuming to measure. In fact, the act of measuring usage of many common services and equipment would be so impractical as to make the measurement more expensive than the service and equipment being sought. As a result, many types of equipment are merely sold to the consumer so that the consumer can use the equipment as much as they want. For example, exercise machines and equipment are typically either sold to individuals for unlimited home use or “rented” to individuals through club memberships that give the consumer access to many exercise machines for a monthly fee. By charging a club membership, all of the various exercise equipment is essentially “bundled” together and the consumer's choice is simply to accept or reject the club membership fee that is offered. Unfortunately, this may be an ineffective pricing scheme for many consumers, such as a runner who will primarily use only one treadmill.

Therefore, there is a need for a method and system for determining a user fee for using a service or equipment that is based on actual usage. Preferably, the user fee is determined by monitoring actual usage of the equipment, attributing the usage to an individual user, and calculating an appropriate user fee. It would be desirable if the usage were automatically measured by monitoring one or more characteristic of the equipment operation, features, or current demand. It would also be desirable if the user fee was calculated as a function of the usage amount and a rate schedule, wherein the rate schedule takes into account one or more rate factor selected from equipment purchase cost, equipment maintenance cost, building space utilization, features used, current usage or demand for the equipment, and the like.

### SUMMARY OF THE INVENTION

The present invention provides a system comprising a memory device and a processor in communication with the memory device. The memory device has one or more database therein for maintaining information relating to a plurality of users and a plurality of devices. The processor is configured to: identify one or more users using a device selected from the plurality of devices that are in communication with the processor, wherein the one or more users are selected from the plurality of users; identify the device used by each of the one or more users; determine, for each of the one or more users, a usage amount attributable to the device; and calculate a user fee for each of the one or more users based on the identity of the device and the usage amount attributable to the device and perhaps also the current demand for the device. Optionally, the processor may be further configured to repeat the foregoing steps for one or more devices, such as fitness equipment, subsequently used by each of the one or more users. Furthermore, the processor may be further configured to accumulate a total of user fees for each of the one or more users. The amount of usage may be measured as a quantity selected from the group consisting of time, repetitions, workload and combinations thereof. It is preferred that the one or more database maintains rate schedules for each of the plurality of devices. The invention allows the possibility that one or more of the rate schedules is variable according to a factor selected from time of day, day of the week, device type, device features, device location, and combinations thereof. In one embodiment, the processor is further configured to display the user fee on the device during use.

Similarly, the invention provides a computer program product including instructions embodied on a computer readable medium. The instructions comprise: storing instructions for storing information relating to a plurality of users and a plurality of devices; identifying instructions for identifying one or more users using a device selected from the plurality of devices that are in communication with the processor, wherein the one or more users are selected from the plurality of users; identifying instructions for identifying the device used by each of the one or more users; determining instructions for determining, for each of the one or more users, a usage amount attributable to the device; and calculating instructions for calculating a user fee for each of the one or more users based on the identity of the device and the usage amount attributable to the device. The computer program product may further include instructions carry out the same steps as the processor as configured above.

More generally, the invention provides a method comprising: storing information relating to a plurality of users and a plurality of devices; identifying one or more users using a device selected from the plurality of devices that are in communication with the processor, wherein the one or more users are selected from the plurality of users; identifying the device used by each of the one or more users; determining, for each of the one or more users, a usage amount attributable to the device; and calculating a user fee for each of the one or more users based on the identity of the device and the usage amount attributable to the device. The method may further include steps that are carried out by the processor as configured above.

The foregoing and other objects, features and advantages of the invention will be apparent from the following more particular description of a preferred embodiment of the invention, as illustrated in the accompanying drawing wherein like reference numbers represent like parts of the invention.

### BRIEF DESCRIPTION OF THE DRAWINGS

FIG. 1 is a structural diagram of a distributed data processing system illustrating the relationship of a server with a plurality of equipment users or clients.

FIG. 2 illustrates an equipment user or client communicating with a server in accordance with the present invention.

FIG. 3 illustrates an example of a client-server system connected through a network.

FIG. 4 is an example of a client computer system in which the present invention may be implemented.

FIG. 5 is an exercise apparatus having a plurality of resistance mechanisms, wherein the exercise equipment is shown as a treadmill.

FIG. 6 is a block diagram representation of the controller of the Internet-connected programmable fitness device.

FIG. 7 is a flowchart illustrating the steps taken by the fitness server in accounting for equipment usage.

FIG. 8 is a structural diagram illustrating fitness equipment communicating through the network to the integrated server.

FIG. 9 is a flowchart illustrating the steps taken by the integrated server

FIG. 10 is a flowchart illustrating the steps taken by the electronic exercise profiler.

FIG. 11 is a flowchart illustrating the steps taken by the electronic dietary profiler.

### DETAILED DESCRIPTION

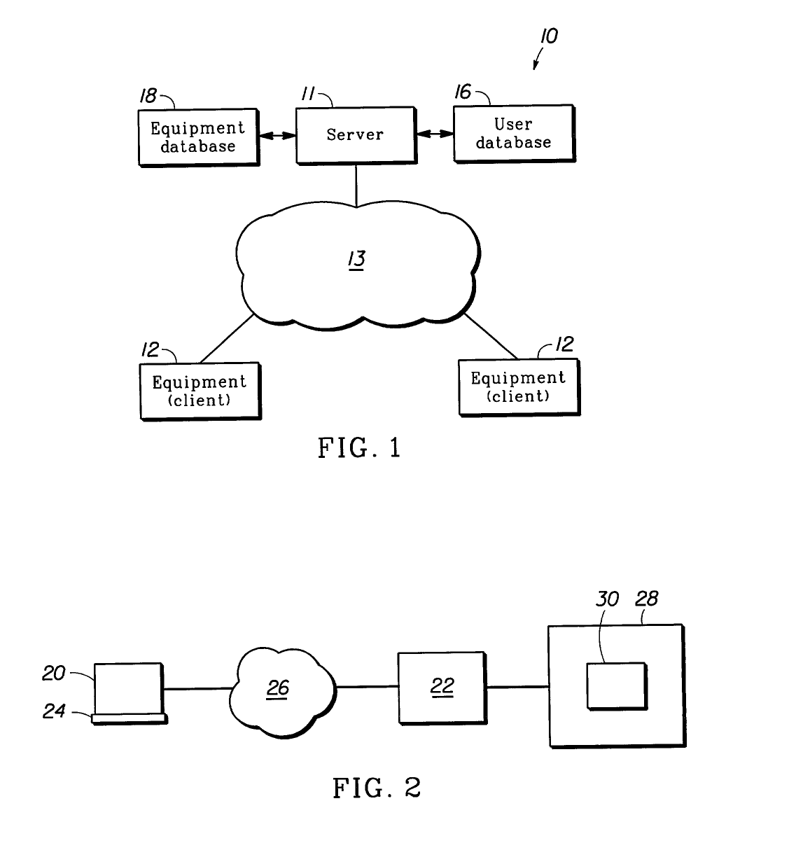

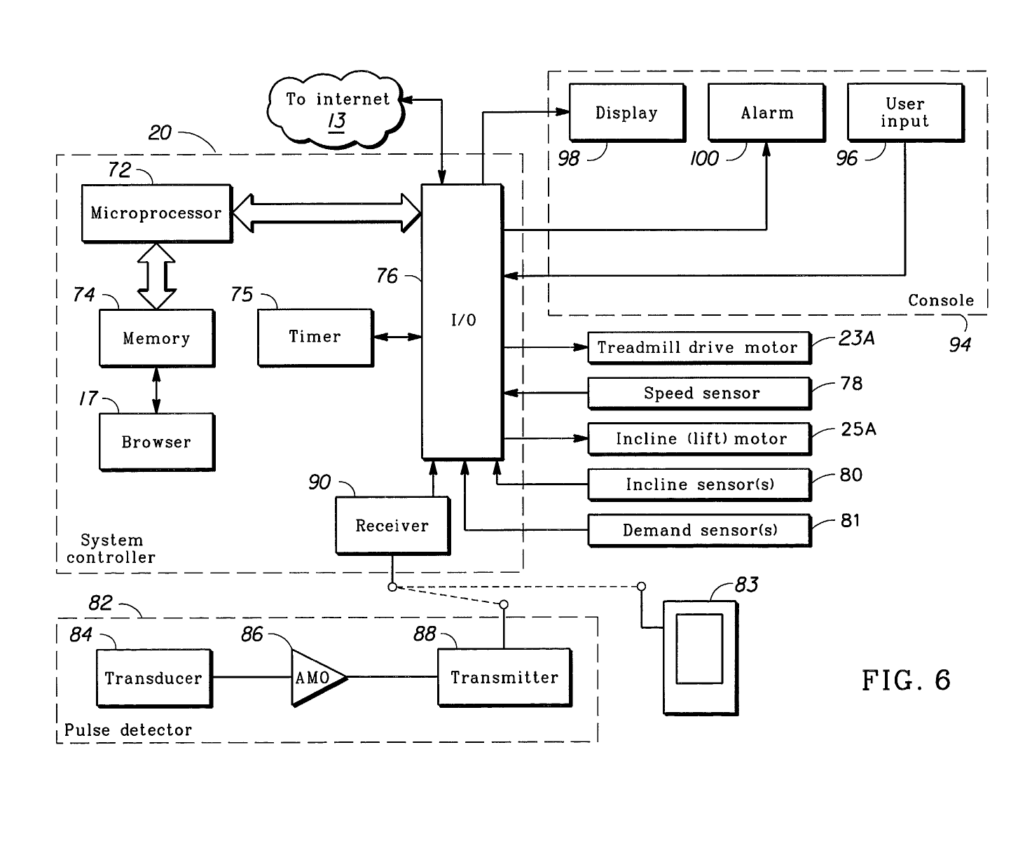

FIG. 1 is a structural diagram of a distributed data processing system 10 illustrating the relationship of a central server 11 with multiple equipment clients or devices 12 for communication over a communications system or network 13, such as the Internet. The system 10 includes programmable equipment 12 interactively coupled with the integrated server 11 that may be disposed at the same location or a location that is geographically remote from the server 11. The system 10 of the present invention includes a user database 16 and an equipment database 18 containing instructions for determining a user fee. The equipment devices 12 access the integrated server 11 through the communications system 13. The interactive coupling permits the equipment 12 to transmit various kinds of user location information to the server 11. It also permits the server 11 to transmit control information to the equipment 12. Information can be transmitted between the equipment 12 and the server 11 at any time, specifically including immediately prior to, during, or immediately after use of the equipment. A preferred equipment device or system 12 is shown in more detail in FIG. 6.

Network 13 is the medium used to provide communications links between various devices and computers connected together within distributed data processing system 10. Network 13 may include permanent connections, such as wire or fiber optic cables, or temporary connections made through telephone or wireless communications. Clients and servers may be represented by a variety of computing devices, such as mainframes, personal computers, personal digital assistants (PDAs), smart phones, and Internet-connected exercise equipment. Distributed data processing system may include additional servers, clients, routers and other devices not shown. In the depicted example, the distributed data processing system 10 may include the Internet with network 13 representing a worldwide collection of networks and gateways that use the TCP/IP suite of protocols to communicate with one another. Of course, the distributed data processing system may also include a number of different types of networks, such as, for example, an intranet, a local area network (LAN), or a wide area network (WAN).

The present invention could be implemented on a variety of hardware platforms and could be implemented in a variety of software environments. A typical operating system may be used to control program execution within the data processing system. Furthermore, although the preferred embodiment described below includes a “browser” at the client as the agent which exchanges data in the security protocols with the Web Application Server, the agent at the client does not have to be a conventional browser, e.g., Netscape Navigator® or Microsoft Internet Explorer®. In order to secure the information transmitted to and from the server, the client may be capable of Public Key Infrastructure (PKI) technology exchanged in a security protocol such as the Secure Sockets Layer (SSL) version 3.0 and above.

Web application server 11 includes a conventional server software program such as International Business Machines' Websphere®, for administering the interaction with equipment users. The server software includes application programs that enable the server 11 to manage the equipment database, user database and any other databases and execute various instructions in response to communications from various equipment users or clients 12.

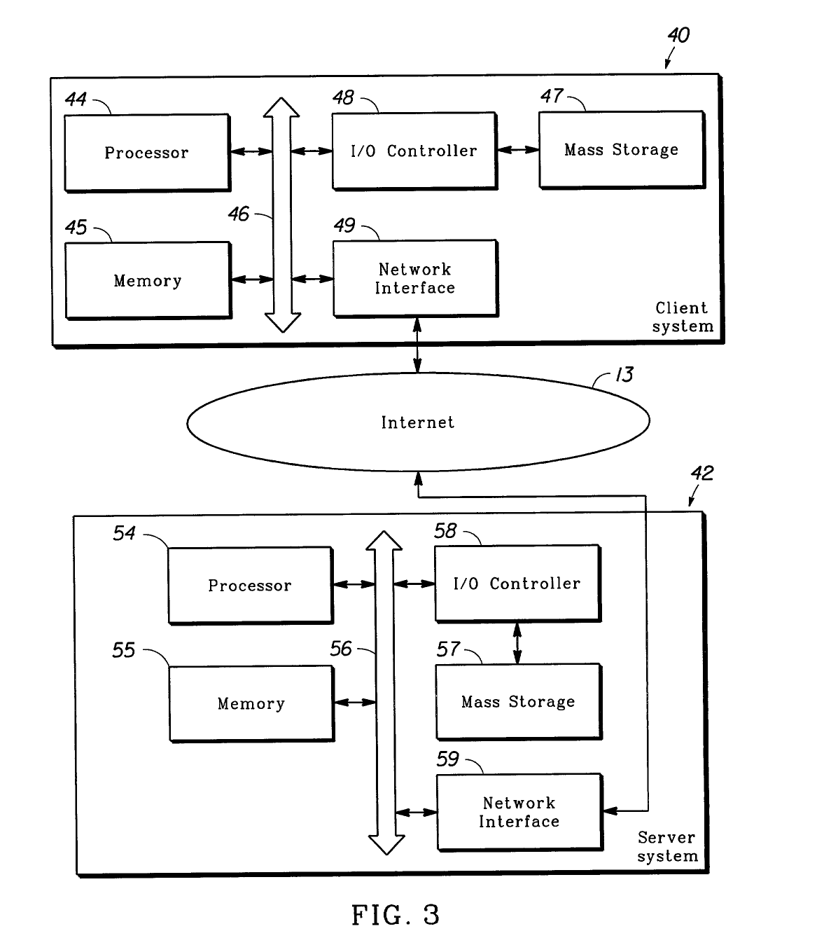

FIG. 2 is an example of a client attempting to access a server according to the present invention. As illustrated, the user of equipment or workstation 20 seeks access over a computer network 26 to an exercise, usage or dietary record 30 located in a database 28 on a server 22 through the user's web browser 24. The computer network 26 may be the Internet, an intranet, or other network. Server 22 may be a Web Application Server (WAS) such as WAS 11 shown in FIG. 1, a server application, a servlet process or the like. Optionally, client 20 submits the required user information to identify itself as being authorized to access the requested information. User information can include data such as a password or a combination of a user identification and password assigned by the server 22. Web server 22 generates a graphical user interface that is displayed by the browser 24 providing the individual options to the client.

FIG. 3 depicts an example of a client-server system connected through the Internet 13. In this example, a remote server system 42 is connected through the Internet to client system 40. The client system 40 includes conventional components such as a processor 44, memory 45 (e.g. RAM), a bus 46 which couples the processor 44 and memory 45, a mass storage device 47 (e.g. a magnetic hard disk or an optical storage disk) coupled to the processor and memory through an I/O controller 48 and a network interface 49, such as a conventional modem. The server system 42 also includes conventional components such as a processor 54, memory 55 (e.g. RAM), a bus 56 which couples the processor 54 and memory 55, a mass storage device 57 (e.g. a magnetic or optical disk) coupled to the processor 54 and memory 55 through an I/O controller 58 and a network interface 59, such as a conventional modem. It will be appreciated from the description below that the present invention may be implemented in software that is stored as executable instructions on a computer readable medium on the client and server systems, such as mass storage devices 47 and 57 respectively, or in memories 45 and 55 respectively.

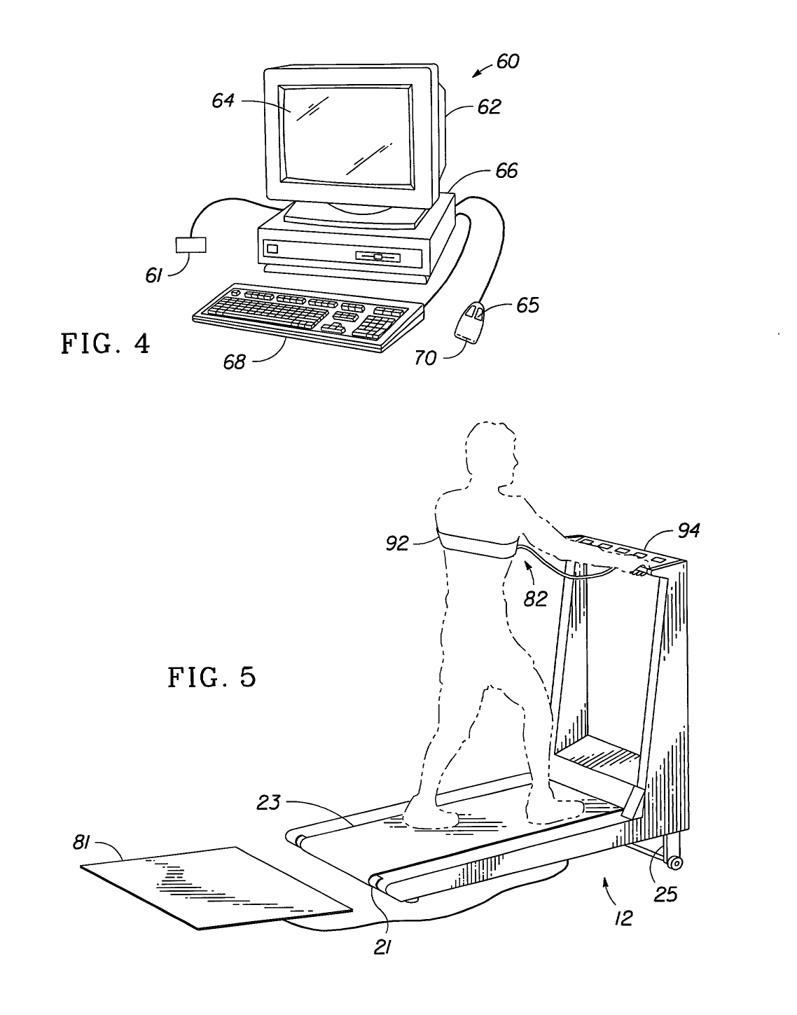

FIG. 4 shows a client computer system 60 that can run a browser. The computer system 60 includes a display device 62 (such as a monitor), a display screen 64, a cabinet 66 (which encloses components typically found in a computer, such as CPU, RAM, ROM, video card, hard drive, sound card, serial ports, etc.), a keyboard 68, a mouse 70, and a modem 61. Mouse 70 may have one or more buttons, such as buttons 65. The computer requires some type of communication device such as modem 61 that allows computer system 60 to be connected to the Internet. Other possible communication devices include ethernet network cards.

Centralized Fitness System

The following section describes a centralized fitness system in accordance with the present invention. This description should be taken as an example of the invention as implemented and should not be interpreted as limiting the scope of the invention.

Referring now to FIG. 5, there is shown an exercise apparatus 12 having a plurality of resistance mechanisms, wherein the exercise equipment 12 is shown as a treadmill. Specifically, the resistance mechanisms are a treadmill drive motor for controlling the speed of the belt 23 and an incline (lift) motor for controlling the lift arm 25. As previously described, it will be understood that the system of the present invention can be applied to any type of equipment. Thus, the fitness device 12 is set forth only as an illustrative example of the type of equipment wherein the present invention can be advantageously applied. Furthermore, the fitness device 12 set forth is only a single example of the many types of fitness devices that can be used within the fitness system 10. Additionally, the device 12 may be fully or partially manually operated, such as a handheld personal data assistant (“PDA”) into which the user types in data to log his running distance, time, repetitions and the like. The console 94 will include a display that is coupled to a controller located somewhere within the fitness device 12. Most preferably, the controller will operate a browser to facilitate Internet communications with the server and other web sites.

Referring now to FIG. 6, there is shown a block diagram representation of the controller 20 of the programmable fitness device 12. The controller 20 can include a microprocessor 72, a memory 74, a timer 75 and input/output (I/O) circuitry 76 connected in a conventional manner. The memory 74 can include random access memory (RAM), read-only memory (ROM), or any other type of storage means. The I/O circuitry 76 can include conventional buffers, drivers, relays and the like, such as for driving the motors 23A, 25A with sufficient power. Conventional circuitry for latching output signals from the microprocessor 72 is also ordinarily included in the output circuitry 76. Thus, output signals from the microprocessor 72, interfaced though the output circuitry 76, control the drive motor 23A and incline motor 25A.

The output signals of the microprocessor 72 also control the display 98 which can be located on a console 94 of the exercise equipment 12. It will be understood that information representative of the operation of any of the devices included in the controller 20 can be interactively transmitted from the controller 20 to the server 11 by way of I/O circuitry 76 that is coupled to the Internet or other network system 13.

Since the speed and incline of the fitness device 12 is determined by the controller 20, the controller 20 normally has all speed and grade information required to operate the fitness control device 12. However, it is preferable to include a speed sensor for detecting the actual speed of the fitness device 12 and an incline sensor for determining the actual grade. Sensors suitable for this purpose are well known to those skilled in the art. For example, a speed sensor 78 can be a conventional Hall effect type sensor adapted to provide a value to the controller 20 that indicates the revolutions per minute of the drive roller 21. The controller 20 can then convert the value received from speed sensor 78 to miles per hour. The incline sensor 80 can be any conventional sensor suitable for the purpose.

In accordance with one aspect of the invention, the resistance levels of the resistance mechanisms 23A, 25A of the fitness device 12 can be varied with respect to one another according to the heart rate of the user. Additionally, the heart rate can be monitored for safety reasons by the controller 20 or the server 11. Accordingly, the fitness device pulse detection circuitry 82 secured to the user by a strap 92 detects the user heart rate. A suitable timer, such as a timer 75, is used to determine the rate of the pulse signals received from the detection circuitry 82. Any conventional pulse detection circuitry 82 can be used provided it can supply a signal corresponding to the user heart rate for the input circuitry 76 of the controller 20. The pulse detection circuitry 82 can include an electrocardiograph-type detection device that senses electric currents or electrical potentials on the user in order to provide a signal corresponding to the heart rate, or any other type of device that senses user heart rate and provides corresponding signals. The output of a transducer 84 within the pulse detection circuitry 82 can be amplified by an amplifier 86 and transmitted by a transmitter 88 to an I/O receiver 90.

Using the fitness system, a user at a user location can interact on-line with a live or programmable fitness expert located at the server 11 to engage in a real time two way communication regarding matters related to fitness, including matters such as exercise routines and exercise equipment. For example, the user can obtain advice on modifying an exercise routine as well as technical support information for various kinds of exercise equipment. In addition to interacting with a live fitness expert, a user of the fitness system at the user location can interactively obtain the control information from the server 11. The communication can include the uploading and downloading of control information, as well as video and audio information, to the fitness device 12. Such communications can be transmitted over fiber optics, wire or utilize wireless technology, such as Wireless Application Protocol (“WAP”) or Bluetooth based communication mechanisms.

The control information transmitted from the server 11 can include control signals for directly controlling the fitness device 12. However, in a preferred embodiment of the fitness system 10, the control information from the server 11 can be a fitness equipment control program for execution by the controller 20. In this preferred embodiment, the controller 20 provides the control signals required for controlling motors 23A, 25A according to the control program received from the server 11. Additionally, a digest of information for each user of fitness system 10 can be accumulated by the server 11 and the control information can be determined according to the digest as well as the current user location information. For example, the web site can store a plurality of control programs and select a control program from the plurality according to the digest and the current user location information.

Although user location information includes both user and location information it will be understood that the user location information at the server 11 can be associated with the actual user rather than any particular geographic location. In this way the user can use fitness system 10 from any location or piece of exercise equipment.

Using the network 13 the user of the fitness system 10 can provide user location information, such as personal identification, heart rate, weight, age and gender, from the user location to the server 11. The user location interactively applies and receives the interactive information from the server through the network

Device information such as speed, incline and suspension can also be communicated by the user or automatically by way of the Internet system 13. Any other information useful for interaction between the user location and the server 12 can also be applied to the Internet system 13. The user information and the device information can be used by the server 11, as well as by the controller 20, to calculate, for example, calorie information. Calorie information calculated in this manner can be used to provide control signals for controlling the fitness device 12 according to the calorie information, both in a current exercise session and in a future one. Information within the fitness system 10 can also be interactively communicated to and from third party applications. An Internet browser 17 permits the user of equipment 12 to browse the Internet system 13 both during and between exercise sessions.

In a preferred embodiment, the rate schedule includes instructions for adjusting the rate charged to users on the basis of current demand for the equipment being used. The current demand may be monitored in various ways, including the use of a pressure-sensitive mat or demand sensor 81 placed on the floor adjacent the equipment on which someone waiting for use of the equipment can stand. Alternatively, demand may be registered by a PDA-operated reservation-type system in which individual's that want to use the equipment transmit a request to the equipment controller to reserve a place in line. The controller may communicate to the PDA how many other individuals are waiting on the equipment, estimate the wait time, and notify the individual when it is their turn. In some contexts, it may be appropriate to have an auction-type system that awards use of the equipment to the highest bidder.

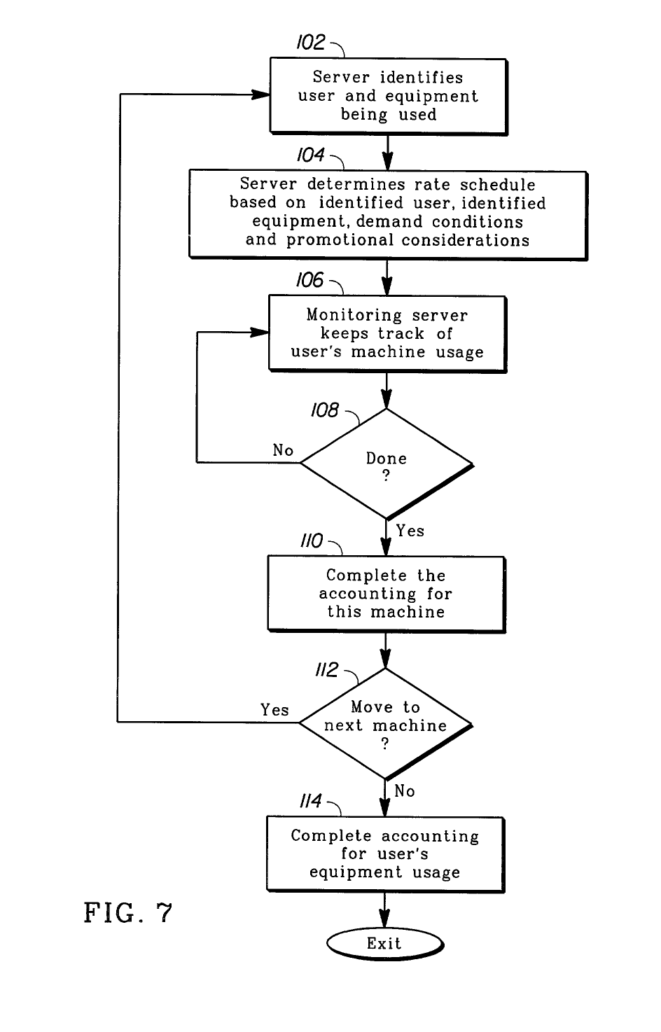

FIG. 7 is a flowchart illustrating the steps taken by the fitness server 11 in accounting for equipment usage. In state 102, the server receives a transmission that allows the server to identify the user and the equipment being used. In state 104, the server determines the rate schedule to be applied based upon the identified user, the identified equipment, current demand conditions, and any promotional considerations. In state 106, the server monitors the amount of usage attributable to the user and the identified equipment. Only upon detecting that the equipment has become idle in state 108, does the server create an event record to be stored in the accounting database in state 110. At a minimum, the event record will debit the users account. More preferably, the event record will record the identified user, identified equipment, user performance information (such as distance, calories, weight, etc.), a time stamp, and any special pricing considerations. The server utilizes the data in the event record to calculate the user fee, preferably using an algorithm that considers demand conditions at the time the equipment was used. In this later manner, the user can be provided with a fully detailed accounting that explains the amounts charged to him. If the user is identified as moving to another device in state 112, then the process returns to state 102. However, if the user is not identified as using any equipment for a timeout period, then the server in state 114 considers the user's session to be complete. Accordingly, the user's health and fitness profile may be updated.

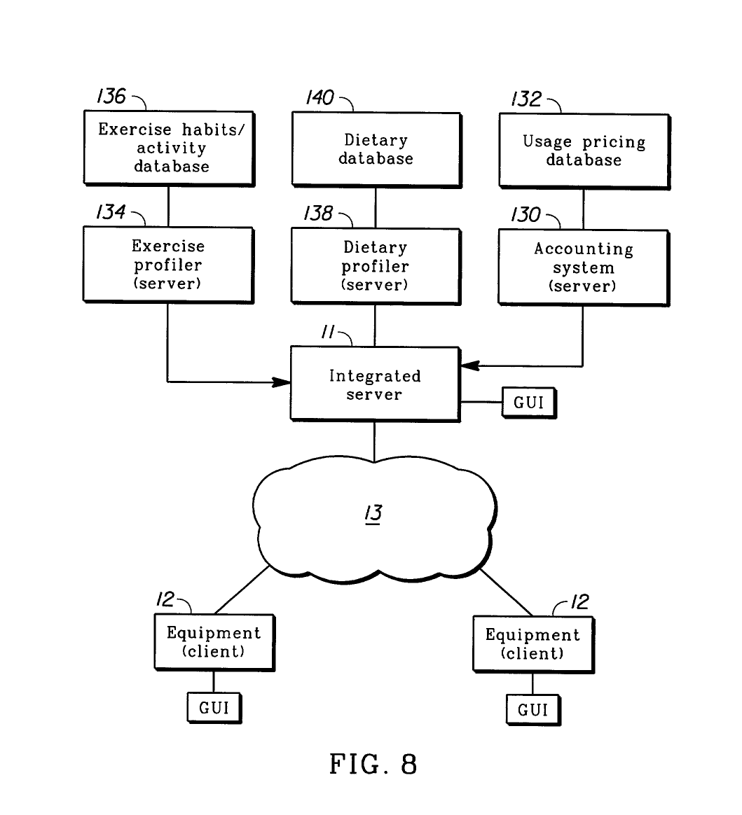

FIG. 8 is a structural diagram illustrating fitness equipment 12 communicating through the network 13 to the integrated server 11. The integrated server 11 includes, or is in communication with, an accounting system or server 130 for determining the user fees to be charged for using one or more fitness device 12. In making a user fee determination, the accounting server 130 must execute certain instructions maintained in the usage pricing database 132 relating to the extent of usage, but preferably also including other instructions relating to the demand for the equipment. These other instructions include, but are not limited to, charging more during busy periods or when there is a long waiting line (high user demand), charging more for the most popular devices, charging less during off-peak hours, charging less during a promotional period, preferential treatment for identified customers, and the like. The usage pricing database 132 is also responsible for maintaining user event records, or at a minimum accumulating total user fees, so that the appropriate amounts can be charged to each user.

The structure in FIG. 8 illustrates a preferred fitness system that includes, or is in communication with, an exercise profiler or server 134 and a dietary profiler or server 138. The electronic exercise profiler 134 maintains the exercise habits and activity database 136 that tracks exercise habits of individual users by storing prior exercise data to create a user exercise profile. Preferably, the fitness profiler 134 communicates with the equipment 12 that is identified as being used by a user that has a fitness profile therein. The communication may include a control signal that automatically performs fitness settings, selected exercise programs and settings (such as duration, level, and type of exercise), or acts as a consultant providing advice. The electronic dietary profiler 138 maintains the diet profile database 140 for making appropriate diet suggestions or menus and, optionally, receiving and storing calorie intake information such as by scanning food items.

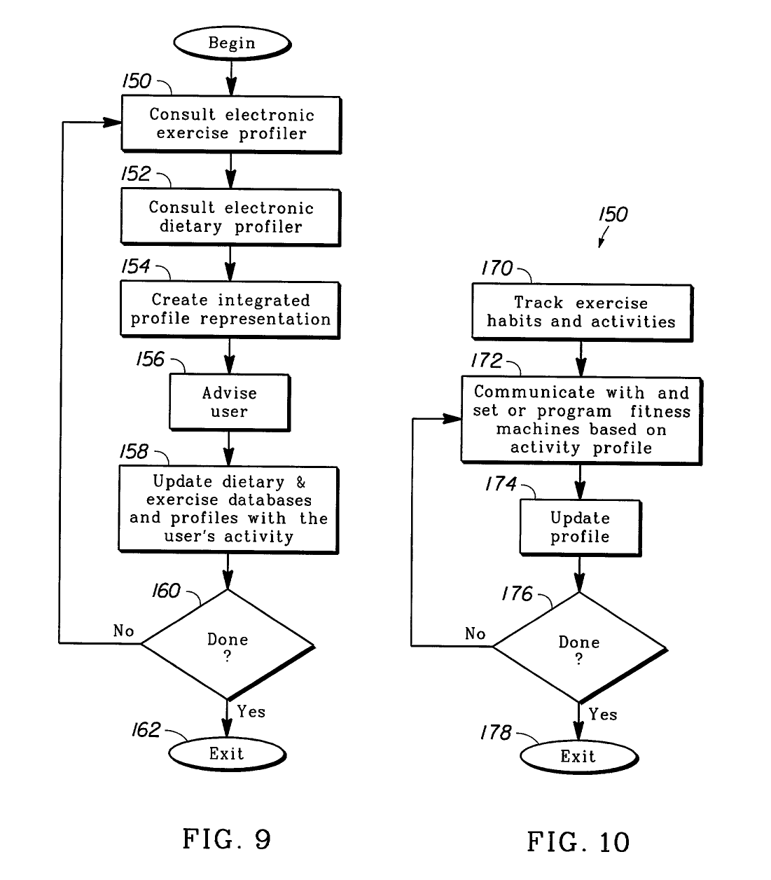

FIG. 9 is a flowchart illustrating the steps taken by the integrated server 11. In states 150 and 152, the integrated server consults the electronic exercise profiler and the electronic dietary profiler, although the order of these steps is not important. In state 154, the integrated server creates a representation of an integrated profile. The user is then advised, in state 156, regarding fitness settings, as well as fitness and dietary advise. Upon conclusion of the exercise event as set out in FIG. 7, the server 11 updates, in state 158, the exercise database 136 and the dietary database 140 with data about the user's activity. Specifically, the exercise database 136 may be given data about speed, incline, duration, and heart beat, while the dietary database 140 may be given data about the number of calories burned and the manually entered weight of the user. If there are no other detected events for the user, as determined in state 160, then the process exits in state 162. However, if the user begins another exercise or requests additional advise, then the process may return to state 150.

FIG. 10 is a flowchart illustrating the steps taken by the electronic exercise profiler 134 during state 150 of FIG. 9. In state 170, the electronic exercise profiler tracks exercise habits and activities that are either manually entered or automatically received from the equipment 12. In state 172, the profiler communicates fitness settings and/or programs to the fitness equipment 12 that are selected on the basis of the exercise habits and activities tracked in state 170 and stored in database 136 during previous exercise sessions. The user's exercise profile is then updated in state 174. If there are no other detected events for the user, as determined in state 176, then the process exits in state 178 (moving to state 152). However, if the user begins another exercise or requests additional advise, then the process may return to state 172.

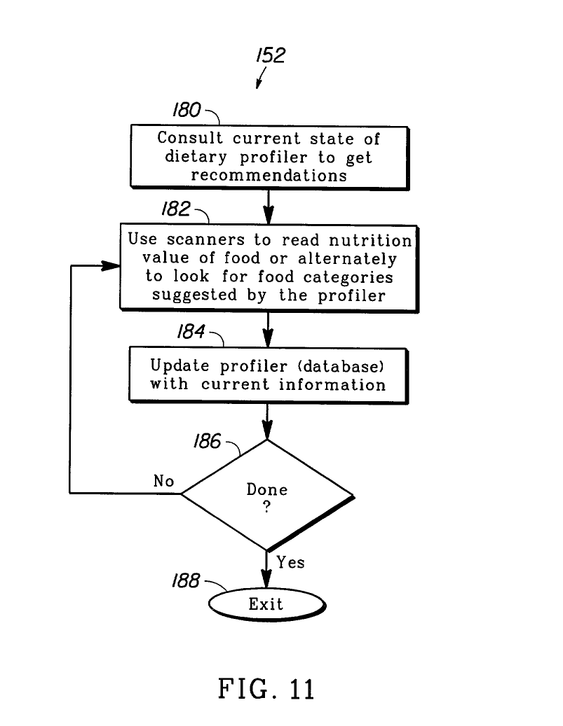

FIG. 11 is a flowchart illustrating the steps taken by the electronic dietary profiler 138 during state 152 of FIG. 9. The profiler 138 consults with the users dietary profile stored in the database 140 in state 180. Based upon the dietary profile, perhaps including the user's weight, exercise frequency and calories burned, and any nutritional information scanned or manually provided, the profiler 138, in state 182, provides dietary advise or suggestions to the user on the display 94 of equipment 12. The user's dietary profile in database 140 is then updated in state 184. If there are no other detected events for the user, as determined in state 186, then the process exits in state 188 (moving to state 154). However, if the user begins another exercise or requests additional advise, then the process may return to state 182.

It will be understood from the foregoing description that various modifications and changes may be made in the preferred embodiment of the present invention without departing from its true spirit. It is intended that this description is for purposes of illustration only and should not be construed in a limiting sense. The scope of this invention should be limited only by the language of the following claims.

What is claimed is:

1. A system comprising:
a memory device having one or more database therein for maintaining information relating to a plurality of users and a plurality of devices;
a processor in communication with the memory device, the processor configured to:
(a) identify one or more users using a device selected from the plurality of devices that are in communication with the processor, wherein the one or more users are selected from the plurality of users;
(b) identify the device used by each of the one or more users;
(c) determine, for each of the one or more users, a usage amount attributable to the device; and
(d) calculate a user fee for each of the one or more users based on the identity of the device and the usage amount attributable to the device.

2. The system of claim 1, wherein the processor is further configured to:
repeat steps (b) through (d) for one or more devices subsequently used by each of the one or more users.

3. The system of claim 2, wherein the processor is further configured to:
accumulate a total of user fees for each of the one or more users.

4. The system of claim 1, wherein the usage amount is a quantity selected from the group consisting of time, repetitions, workload and combinations thereof.

5. The system of claim 1, wherein the one or more database maintains rate schedules for each of the plurality of devices.

6. The system of claim 5, wherein one or more of the rate schedules is variable.

7. The system of claim 5, wherein the one or more of the rate schedules is variable according to a factor selected from time of day, day of the week, device type, device features, device location, concurrent demand for using the device, and combinations thereof.

8. The system of claim 1, wherein the processor is further configured to:
accumulate the user fee over a period of time comprising two or more sessions of use.

9. The system of claim 1, wherein the one or more devices are exercise devices.

10. The system of claim 1, wherein the processor is further configured to:
display the user fee on the device during use.

11. A computer program product including instructions embodied on a computer readable medium, the instructions comprising:
(a) storing instructions for storing information relating to a plurality of users and a plurality of devices;
(b) identifying instructions for identifying one or more users using a device selected from the plurality of devices that are in communication with the processor, wherein the one or more users are selected from the plurality of users;
(c) identifying instructions for identifying the device used by each of the one or more users;
(d) determining instructions for determining, for each of the one or more users, a usage amount attributable to the device; and
(e) calculating instructions for calculating a user fee for each of the one or more users based on the identity of the device and the usage amount attributable to the device.

12. The computer program product of claim 11, further comprising:
repeat instructions for repeating steps (b) through (e) for one or more devices subsequently used by each of the one or more users.

13. The computer program product of claim 12, further comprising:
accumulating instructions for accumulating a total of user fees for each of the one or more users.

14. The computer program product of claim 11, wherein the usage amount is a quantity selected from the group consisting of time, repetitions, workload and combinations thereof.

15. The computer program product of claim 11, wherein the one or more database maintains rate schedules for each of the plurality of devices.

16. The computer program product of claim 15, wherein one or more of the rate schedules is variable.

17. The computer program product of claim 15, wherein the one or more of the rate schedules is variable according to a factor selected from time of day, day of the week, device type, device features, device location, concurrent demand for using the device, and combinations thereof.

18. The computer program product of claim 11, further comprising:
accumulating instructions for accumulating the user fee over a period of time comprising two or more sessions of use.

19. The computer program product of claim 11, wherein the one or more devices are exercise devices.

20. The computer program product of claim 11, further comprising:
display means for displaying the user fee on the device during use.

21. A method comprising:
(a) storing information in a processor relating to a plurality of users and a plurality of devices;
(b) identifying one or more users using a device selected from the plurality of devices that are in communication with the processor, wherein the one or more users are selected from the plurality of users;
(c) identifying the device used by each of the one or more users;
(d) determining, for each of the one or more users, a usage amount attributable to the device; and
(e) calculating a user fee for each of the one or more users based on the identity of the device and the usage amount attributable to the device.

22. The method of claim 21, further comprising:
repeating steps (b) through (e) for one or more devices subsequently used by each of the one or more users.

23. The method of claim 22, further comprising:
accumulating a total of user fees for each of the one or more users.

24. The method of claim 21, wherein the usage amount is a quantity selected from the group consisting of time, repetitions, workload and combinations thereof.

25. The method of claim 21, wherein the one or more database maintains rate schedules for each of the plurality of devices.

26. The method of claim 25, wherein one or more of the rate schedules is variable.

27. The method of claim 25, wherein the one or more of the rate schedules is variable according to a factor selected from time of day, day of the week, device type, device features, device location, concurrent demand for using the device, and combinations thereof.

28. The method of claim 21, further comprising:
accumulating the user fee over a period of time comprising two or more sessions of use.

29. The method of claim 21, wherein the one or more devices are exercise devices.

30. The method of claim 21, further comprising:
displaying the user fee on the device during use.

31. A system comprising:
a memory device having a fitness database and a dietary database, each database maintaining information relating to a plurality of users;
a processor in communication with the memory device, the processor configured to:
(a) identify one or more users using a fitness device selected from a plurality of fitness devices that are in communication with the processor, wherein the one or more users are selected from the plurality of users;
(b) accessing fitness records for each of the one or more identified users in the fitness database;
(c) accessing dietary records for each of the one or more identified users in the dietary database; and
(d) providing each of the one or more identified users with health advise based upon the fitness records and the dietary records, wherein the health advise is selected from the group consisting of exercise equipment settings, training considerations, exercise body mechanics, food selections, calorie counting, and combinations thereof.

32. The system of claim 31, wherein the processor is further configured to:
repeat steps (a) through (d) for one or more devices subsequently used by each of the one or more users.
